(19) United States
(12) Patent Application Publication
(10) Pub. No.: US 2010/0313260 A1
(43) Pub. Date: Dec. 9, 2010

(54) METHOD AND SYSTEM OF PROVIDING FIREWALL IN HANDSET

(75) Inventor: Jun Liu, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTSRY (ShenZhen) CO., LTD., Shenzhen City (CN); HON HAI PRECISION INDUSTRY CO., LTD., Tu-Cheng (TW)

(21) Appl. No.: 12/548,116

(22) Filed: Aug. 26, 2009

(30) Foreign Application Priority Data
Jun. 5, 2009 (CN) 200910302941.X

(51) Int. Cl. G06F 15/16; H04M 3/42

(52) U.S. Cl. 726/11; 379/210.02

(57) ABSTRACT

A method of providing firewall in handset is disclosed. The method includes receiving a request with a telephone number by a handset. The handset determines if the telephone number meets a refusing condition. The refusing condition includes a telephone number interval with at least one number and a symbolic variable. The handset refuses the request of the telephone number if the telephone number meets the refusing condition.

### BACKGROUND

1. Technical Field

The present disclosure relates to a method and a system of providing a firewall and, particularly, to a method and a system of providing a firewall in a handset.

2. Description of Related Art

A firewall is a part of a computer system or network that is designed to block unauthorized access while permitting authorized communications. It is a device or set of devices configured to permit, deny, encrypt, decrypt, or proxy all (in and out) computer traffic between different security domains based upon a set of rules and other criteria. If a user does not want to receive others' call, the firewall can be utilized.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a diagram of a system of providing a firewall in a handset.

FIG. 2 is a flow chart of a method of providing a firewall in a handset.

FIG. 3 is a first schematic view of a method of providing firewall in handset.

FIG. 4 is a second schematic view of the method of providing firewall in handset.

FIG. 5 is a third schematic view of the method of providing firewall in handset.

FIG. 6 is a fourth schematic view of the method of providing firewall in handset.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

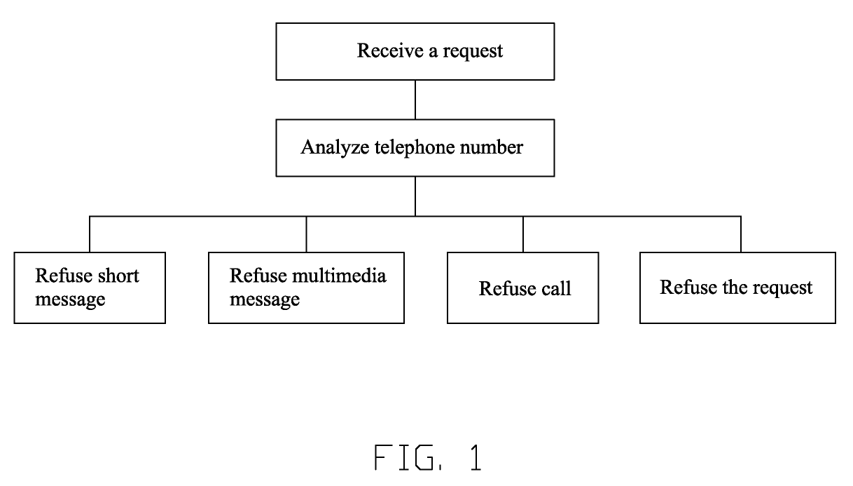

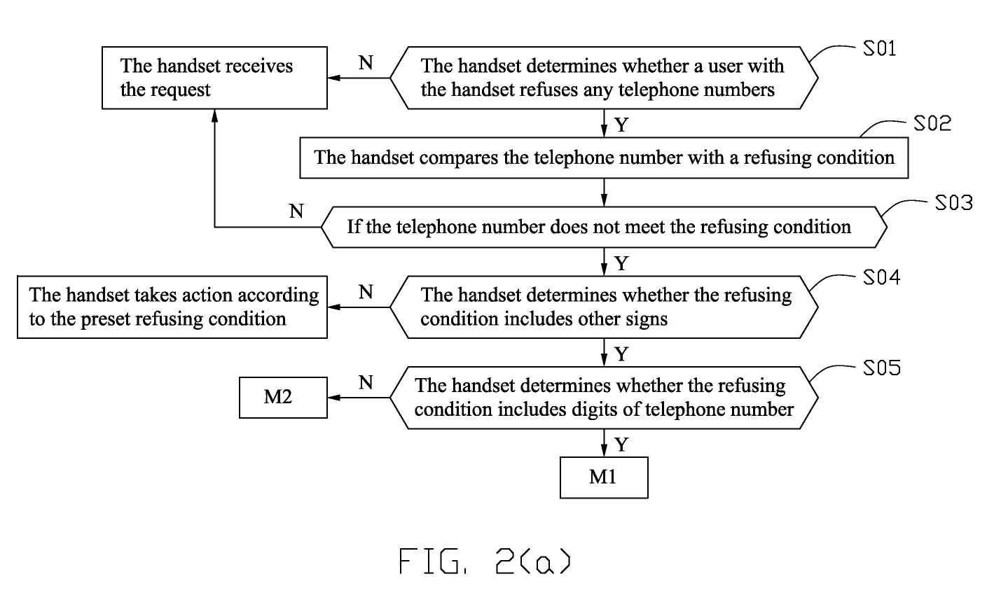

Referring to FIG. 1, a system of providing a firewall in a handset is disclosed. A handset has a central processing unit (CPU). A firewall is installed in the handset. The firewall includes code executable by the CPU for controlling the handset to receive or refuse an request with a telephone number. When the handset receives an request (e.g. a call or message) the handset analyzes the request and the associated telephone number, and takes action according to the result. The actions may include refusing a short message, refusing a multimedia message, refusing an email, refusing a call, and receiving the request.

When the handset receives the request with the telephone number, the CPU determines if the telephone number meets a refusing condition. The refusing condition includes a telephone number, at least one number and a symbolic variable, digits of the telephone number, the number of times that the handset refuses the telephone number, and the time that the handset refuses the telephone number. The handset refuses the request of the telephone number if the telephone number meets the refusing condition.

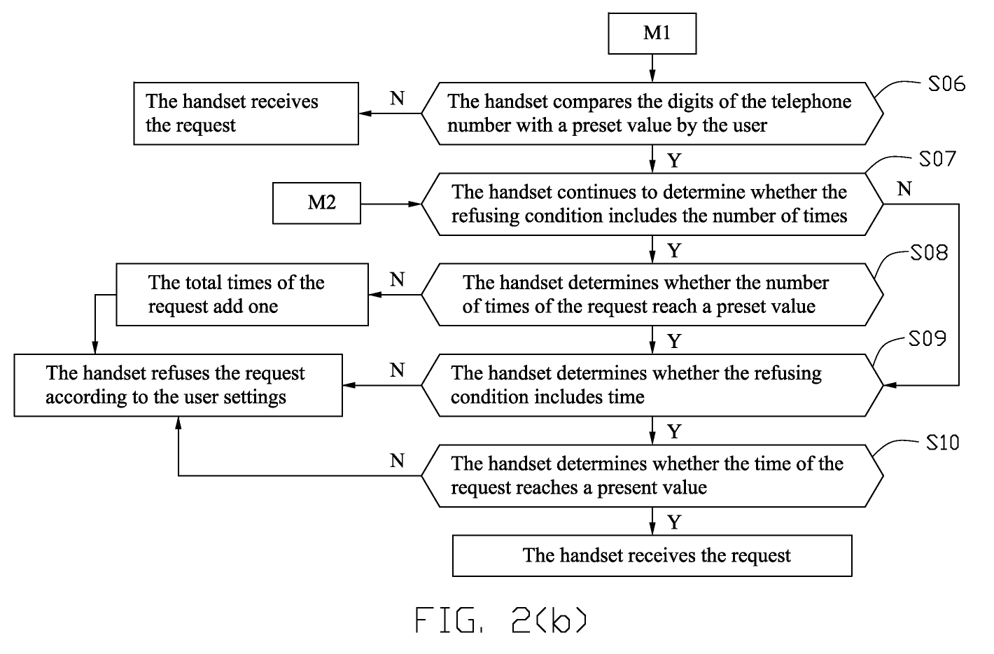

Referring to FIG. 2, the method of providing a firewall in a handset includes the following steps:

S01: the handset receives the request. The request includes the call receiving request, the short message receiving request, and so on.

S02: the handset determines whether the handset refuses/blocks any telephone numbers. If the handset has no restrictions, the handset receives the request. If the handset refuses some telephone numbers, proceed to S03.

S03: the handset compares the telephone number with a refusing condition. The refusing condition is set by the user. The refusing condition includes a range of telephone numbers indicated by at least one number and/or a symbolic variable.

S04: if the telephone number does not meet the refusing condition, the handset receives the request. If the telephone number satisfies the refusing condition, go to S05.

S05: the handset determines whether the refusing condition includes other signs (e.g. “+”, parenthesis). If the refusing condition does not include other signs, the handset takes action according to the preset refusing condition. If the refusing condition includes other signs, skip to S06.

S06: the handset determines whether the refusing condition includes digits of telephone number. If the refusing condition does not include the digits, proceed to S08; if not, then to S07.

S07: the handset compares the digits of the telephone number with a preset value by the user. If the digits are different from the preset value, the handset receives the request, such as the handset receives the call. If not, proceed to S08.

S08: the handset continues to determine whether the refusing condition includes the number of times. If the refusing condition does not include the number of times, skip to S10. If not, then to S09.

S09: the handset determines whether the number of request reach a preset value. For example, the handset is set to refuse 50 times of the call. If the times do not reach the preset value, then one is added to the number of request. The handset refuses the request according to the user settings. If not, then to S10.

S10: the handset determines whether the refusing condition includes a time condition that the handset can refuse the telephone number. For example, the handset can be set to refuse short messages inform the number for the next 24 hours. If the refusing condition does not include the time condition, the handset can refuse the request according to the user settings. If not, then to S11.

S11: the handset determines whether the time of the handset refusing the request reaches a preset value. If the time does not reach the preset value, the handset refuses the request according to the user settings. If not, the handset receives the request.

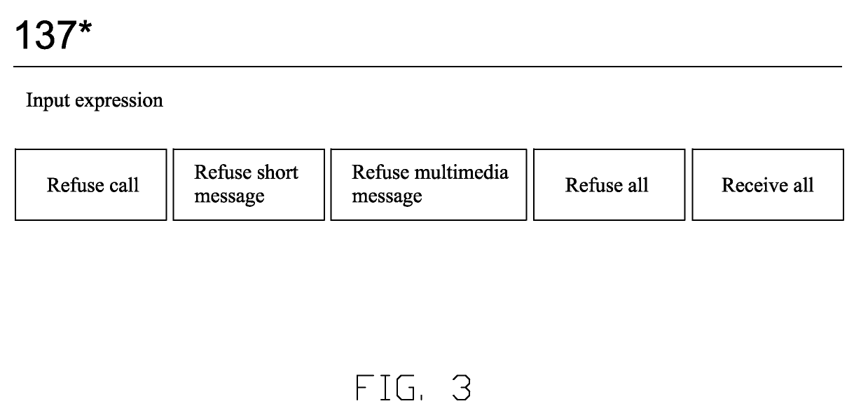

Referring to FIG. 3, when the user sets ###* (e.g. 137*) in the handset, the handset would refuse telephone numbers beginning with the digits ### (e.g. 137). A display screen of the handset displays a menu of actions. For example, refuse call, refuse short message, refuse multimedia message, refuse email, refuse all, receive all.

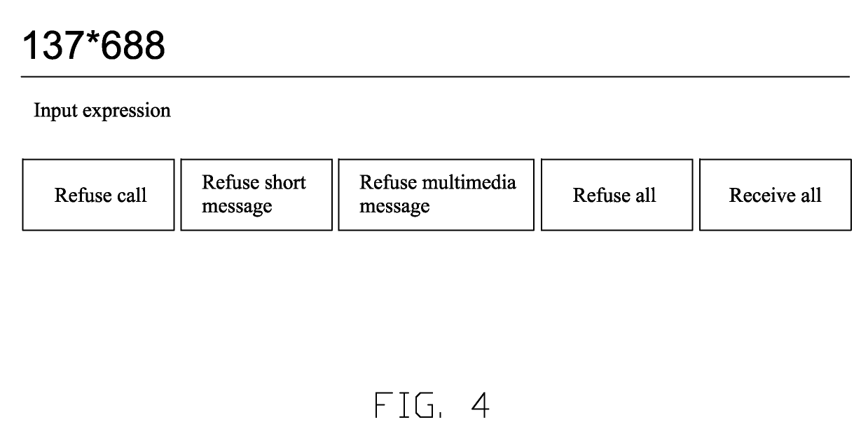

Referring to FIG. 4, when the user sets ###*### (e.g. 137*688), the handset refuses telephone numbers with the digits ### (e.g. 137) at the beginning and the digits ### (e.g. 688) at the end. The “*” signal indicates any numbers between “137” at the beginning and “688” at the end. If the user wants to refuse short messages of the telephone numbers, the user only need to select to refuse short message. “*” signal may be replaced by other signs to express the same meanings.

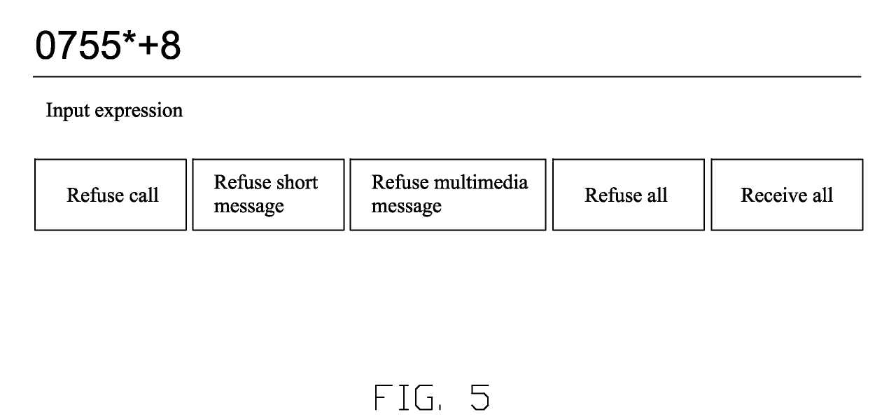

Referring to FIG. 5, when the user sets ####*+# (e.g. 0755*+8) in the handset, the handset refuses telephone numbers as #### (e.g. 0755) at the beginning of a phone number that includes # (e.g. 8) more digits. The “+” sign expresses the digits of the telephone numbers.

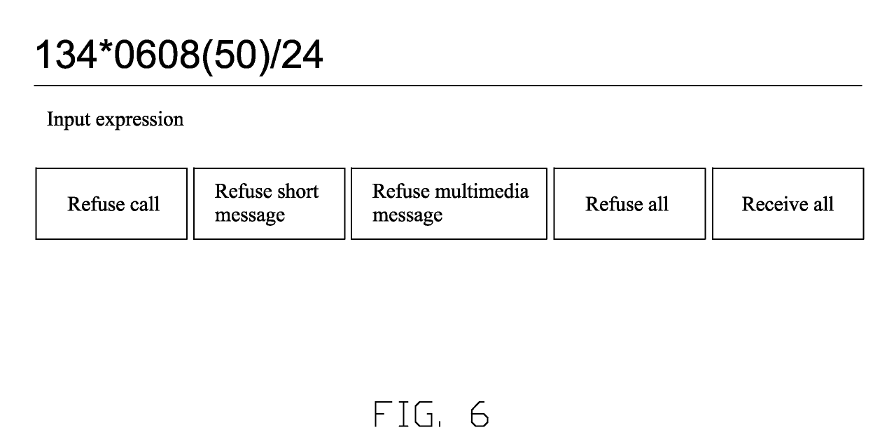

Referring to FIG. 6, when the user sets ###*####(##)/## (e.g. 134*0608(50)/24) in the handset and selects to refuse short message, the handset refuses the first 50 short messages in 24 hours from telephone numbers with digits 134 at the beginning and the digits 0608 at the end.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. A method of providing firewall in handset, comprising:
receiving a request associated with a telephone number by a handset;
determining if the telephone number meets a refusing condition, the refusing condition comprising a range of telephone number indicated by at least one number and a symbolic variable; and
refusing the request of the telephone number if the telephone number meets the refusing condition.

2. The method of claim 1, wherein the refusing condition further comprises digits of the telephone number equal to a predetermined value.

3. The method of claim 1, wherein the refusing condition further comprises the number of times that the handset refuses a telephone number.

4. The method of claim 1, wherein the refusing condition comprises a time condition<.

5. The method of claim 1, wherein the request is a short message receiving request.

6. The method of claim 1, wherein the request is a multimedia message receiving request.

7. The method of claim 1, wherein the request is a call receiving request.

8. The method of claim 1, wherein the request is an email receiving request.

9. A system of providing firewall in handset, comprising:
a handset having a CPU;
a firewall installed in the handset, the firewall comprising code executable by the CPU for controlling the handset to receive or refuse an request having a telephone number associated therewith;
wherein the handset is capable of receiving an request with the telephone number; the CPU is capable of determining if the telephone number meeting a refusing condition; the refusing condition comprises a telephone number interval with at least one number and a symbolic variable; the handset is capable of refusing the request of the telephone number if the telephone number meets the refusing condition.

10. The system of claim 9, wherein the refusing condition comprises digits of the telephone number equal to a predetermined value.

11. The system of claim 9, wherein the refusing condition comprises the number of times of refusing the telephone number.

12. The system of claim 9, wherein the refusing condition comprises time condition.

13. The system of claim 9, wherein the request is a short message receiving request.

14. The system of claim 9, wherein the request is a multimedia message receiving request.

15. The system of claim 9, wherein the request is a call receiving request.

16. The system of claim 9, wherein the request is an email receiving request.
